(19) United States
(12) Patent Application Publication
(10) Pub. No.: US 2024/0061973 A1
(43) Pub. Date: Feb. 22, 2024

(54) OPTIMISATION OF PHYSICAL AND/OR GEOMETRIC PROPERTIES OF A STRUCTURE THROUGH ITERATIVE VARIATION OF SHAPE PARAMETERS

(71) Applicants: Centre National de la Recherche Scientifique, PARIS (FR); Université Clermont Auvergne, CLERMONT-FERRAND (FR); Clermont Auvergne INP, Aubière Cedex (FR)

(72) Inventor: Kofi EDEE, Cournon d'Auvergne (FR)

(21) Appl. No.: 18/261,255

(22) PCT Filed: Jan. 13, 2022
(86) PCT No.: PCT/FR2022/050065

§ 371 Date: Jul. 12, 2023

(30) Foreign Application Priority Data
Jan. 13, 2021 (FR) FR2100307

(51) Int. Cl. G06F 30/20

(52) U.S. Cl. CPC G06F 30/20; G06F 2111/10

(57) ABSTRACT

The method comprises an optimization step involving calculating a figure of merit representative of the sensitivity of the selected response to first sequence variations in first design variables and second sequence variations in second design variables of the spaces and substructures, then calculating a gradient of the figure of merit, subsequently modifying first or second design variables of at least one of the first and second sequences depending on said gradient in order to improve the figure of merit, and repeating the optimization step as long as the figure of merit does not represent a set objective and/or is lower than a selected value, wherein the first P+S design variables of the first sequence and the second P+S design variables of the second sequence are substructure (3p) or space (4s) widths between substructures (3p), which widths are defined in one of three different directions of a three-dimensional space.

### TECHNICAL FIELD OF THE INVENTION

The invention relates to the optimization of physical and/or geometric properties of structures comprising sub-structures separated from one another by spaces.

### STATE OF THE ART

In certain technical fields, such as for example those of optics, photonics, and plasmonics, structures that comprise P sub-structures separated from each other by S spaces and each comprising at least one layer of a material, where P≥2 and S≥1, are used. These structures are intended to each have a selected response to an electromagnetic excitation selected by at least one electromagnetic source. For example, such a structure may be a miniaturized diffraction grating (or metagrating) charged to diffract light at a predefined deflection angle, or a miniaturized lens (or metalens) to focus an incident planar wave toward a focusing point.

In order to produce structures offering particular responses, it has been proposed to implement methods of inverse design. Considering a given solution, the purpose of this type of method consists of finding problems, and preferably a single problem, associated with this solution, by following a particular methodology.

Among optimization methods involving inverse design, those based on a so-called adjoint-based method or technique have proven to be very effective. These methods consist of carrying out two simulations: one called direct and one called adjoint (or reciprocal).

From a mathematical point of view, in this type of topological optimization method we consider a set of equations parameterized by a sequence of variables, generally called design parameters, and the aim is to calculate a function called figure of merit (representative of the efficiency of the structure's response to an electromagnetic excitation), dependent on these design parameters and on the solutions of these equations. For example, in photonics, it may be given as a solution or objective to maximize the electromagnetic power transmitted according to a particular direction of the space (solution obtained from Maxwell's equations with certain boundary conditions), and it is possible to find a structure comprising a selected number of sub-structures of widths less than the considered wavelength and that make it possible to achieve this objective. It is also possible to find a structure that makes it possible to focus a power flow at a predefined point, in reflection or in transmission.

In practice, knowledge of the figure of merit is already very useful, but knowing the gradient g of the figure of merit proves even more useful. That is because this gradient is representative of how sensitive the response of the structure being optimized is to the design parameters. This gradient thus indicates the direction wherein research is to be carried out to increase (or improve) the figure of merit and thus achieve the objective set with a minimal cost. However, the number of design parameters may prove to be very large, thus leading to an excessively long calculation time, required by the optimization process, especially during the evaluation of the gradient g of the figure of merit.

“Adjoint-based” optimization methods make it possible to estimate the gradient g of the figure of merit with a low cost in terms of computing time. These methods are often coupled to descending or ascending gradient methods which are iterative methods. Therefore, the final result depends on the initial conditions (starting points). Recent work has demonstrated the effectiveness of topological adjoint-based optimization methods that use, as starting points, continuous functions of the design variable. They consist of a continuous initial profile describing the electromagnetic properties of the structure and transforming this profile into pixels by means of a sequence of voxels, and, at each iteration, calculating the gradient g of the figure of merit in each voxel of the design domain. The gradient g is used to modify the values of the design parameters at each voxel in order to improve the figure of merit. During each iteration, the continuous profile is converged toward a discrete (final) profile by applying a “blurring” procedure and a “binarization” procedure. The blurring consists of applying a low filter to gradually smooth the profile, while the binarization procedure consists of gradually pushing the continuous profile, during optimization, toward a discontinuous profile. The calculation of the gradient g is carried out in two phases.

In a first phase (called “forward simulation”), the structure being optimization is illuminated, in one direction, by a particular excitation which, for example, can be a polarized flat wave or a point source of the dipole type or a source line. This amounts to solving Maxwell's equations for a particular geometric configuration, in the presence of a particular excitation.

In a second phase (called “adjoint simulation”), Maxwell's equations are solved for the same geometric configuration as previously, but in the presence of an excitation illuminating the structure being optimized in a direction of propagation opposite the direction of propagation of the excitation used in the first phase for a structure operating in transmission, or in the same direction for a structure operating in reflection. For example, it is possible to back-illuminate the structure from the direction wherein, or from the point (place) which, it is desired to optimize the power conveyed by the electromagnetic wave.

For example, if the structural design of a deflector has the function of channeling a maximum share of incident energy toward a given direction, forward simulation consists of illuminating the structure being optimized along a given incident direction and calculating the transmission coefficient for a structure operating in transmission, or the reflection coefficient for a structure operating in reflection. Adjoint simulation consists of reusing the transmission coefficient, or the reflection coefficient depending on the scenario, calculated by forward simulation to excite the structure in the optimization direction, in the retrograde (or reverse) direction.

In the case of the optimization of a lens operating in transmission, forward simulation consists of illuminating the structure to be optimized along a given incident direction, whereas in the adjoint problem, the structure is excited in the retrograde direction (reverse), using a point source placed at the point where the incident electromagnetic power is to be focused.

The major drawback of the methods described above lies in the fact that they require the use of a large number of voxels so that the final structure offers high performance. Typically, at least 2⁸ voxels are required to optimize a one-dimensional (1D) structure of the meta-network type, and the larger the dimensions of the structure, the greater the number of voxels required.

Furthermore, the larger the number of dimensions of the structure (2D or 3D), the greater the number of voxels required. In other words, the larger and/or complex the structure, the more unsuitable the methods described above are to its optimization.

Another drawback of the methods described above lies in the fact that they implement a so-called “gradient descent” technique which consists of searching for successive local minima of an objective function. However, the last local minimum retained (or final result) depends heavily on the starting point used at the beginning of the gradient descent technique, making it necessary to perform a large number of calculations by randomly testing several initial starting points before an acceptable result is found. Furthermore, the variation in the gradient g as a function of the design parameters is a real quantity. However, as this quantity g is used to modify the design variables in order to improve the figure of merit, when the design variable is of complex value (and therefore has a real part and an imaginary part), the method as it presently exists is inapplicable. This is the case, for example, of lossy or metallic dielectric structures. In both cases, the design variables are the values of the permittivity function are complex numbers.

The object of the invention is therefore in particular to remedy all or some of the aforementioned drawbacks by acting on design variables via design parameters which are shape parameters and therefore whose values are always real.

### OVERVIEW OF THE INVENTION

To this end, it proposes a method intended to allow, for its production, the optimization of a structure comprising P sub-structures separated from each other by S spaces and each comprising at least one layer of a material, where P≥2 and S≥1, so that this structure has a selected response to an electromagnetic excitation selected by at least one electromagnetic source.

This method is characterized by the fact that it comprises an optimization step involving calculating a figure of merit representative of a sensitivity of the selected response to first sequence variations in first design variables and second sequence variations in second design variables of the spaces and sub-structures, then calculating a gradient of the calculated figure of merit, subsequently modifying (for example gradually and successively) first or second design variables of at least one of the first and second sequences (for example starting with the most sensitive variable of the sequence concerned) depending on that calculated gradient in order to improve the figure of merit, and repeating the step of optimization with the first and second sequences of modified design variables as long as the figure of merit does not represent a set objective and/or the figure of merit is less than a selected value.

These first P+S design variables of the first sequence and second P+S design variables of the second sequence may be sub-structure 3ₚ or space widths between sub-structures defined in one of three different directions of a three-dimensional space.

Thus, instead of using a continuous initial profile describing the electromagnetic properties of the structure and continuously modifying this profile in each voxel position of the design domain, the widths of the elements of the structure (sub structures and spaces) are altered directly, gradually and iteratively, by altering their boundaries. The boundaries constituting the design parameters whose modifications obtained by means of the method according to the invention make it possible to achieve the objective carried by the figure of merit. Since the variables-boundaries are much fewer in number than the voxels, the method according to the invention is much more efficient and much faster than that of the prior art. It is therefore now possible to optimize larger and/or more complex structures, including non-periodic diffraction metagratings or metasurfaces.

The method according to the invention may comprise other features which can be taken separately or in combination, and in particular:
it may comprise an initialization step wherein first and second sequences of design variables are generated, referred to as initial sequences and each comprising P+S design variables. In this case, in a first optimization step, these initial first and second design variable sequences are transformed respectively into a third sequence of third P+S design variables and a fourth sequence of fourth P+S design variables, and then the figure of merit is calculated from these third P+S design variables of the third sequence and fourth P+S design variables of the fourth sequence, and then in each iteration of the optimization step (subsequent to the first), the figure of merit is calculated from the third sequence of new P+S design variables derived from transformations of the first sequence of first P+S design variables determined during the previous optimization step and of the fourth sequence of new fourth P+S design variables determined during the preceding optimization step, and each of said third design variables of the third sequences and fourth P+S design variables of the fourth sequences represents a substructure position or space between substructures position with respect to an origin and along the direction of three-dimensional space wherein the width is defined, each position being equal to a sum between a previous position and the corresponding first or second design variable;
in each optimization step, it is possible to calculate, in a sub-step of optimizing at most P+S sub-iterations, a sequence of at most P+S sensitivity parameters depending respectively on the gradient of the figure of merit, then it is possible to calculate iteratively at each of the P+S sub-iterations a pair of fifth variables from respectively the third P+S design variables of the third sequence, the corresponding P+S sensitivity parameters, and at least one selected constraint, starting with the third design variable having the strongest sensitivity in the third sequence (that is, the one whose gradient value (g) is the highest), and ending with the third design variable having the lowest sensitivity, then it is possible to determine from among a triplet comprising the pair of fifth variables calculated during the considered sub-iteration of the current iteration (t) and the third design variable from which the fifth variables are calculated, the best of these two fifth variables and of this third design variable according to a chosen criterion, then it is possible to update a new third sequence of at most P+S third design variables composed of the best of these two fifth variables and third design variable according to a chosen criterion and from the remainder of the sequence of at most P+S−1 remaining third design variables, then it is possible to constitute a new fourth sequence with the updated third sequence, then it is possible to calculate a new second sequence of new second P+S design variables from the new fourth sequence of fourth design variables, then it is possible to generate a new first sequence of new first P+S design variables from respectively the new second P+S design variables of the new second sequence and from P+S corresponding noise parameters, then it is possible to calculate a new third sequence of new third P+S design variables from the new first P+S design variables of the new first sequence;
each constraint may, for example, be selected from a group comprising a minimum width and a maximum width;
in each optimization step, the figure of merit can be calculated from forward and adjoint simulations using the corresponding third design variable, and either a forward simulation using the corresponding fourth design variable during the first optimization step, or the corresponding new fourth design variable generated during the preceding optimization step;
in each forward simulation and in each adjoint simulation, an electromagnetic source constituting a dipole or a source line or a plane wave (polarized or not) or a guided mode of a waveguide can be used;
the structure may have a geometry having a periodicity in at least one of three different directions of a three-dimensional space. For example, the structure may have a geometry made of an arrangement (random or controlled) of sub-structures and space(s) between sub-structures forming at least one discrete elementary design and having a canonical form which is selected from a group comprising a line, a rectangle, a cylinder, a sphere, a parallelepiped, a ring, and a set of concentric or off-centered rings;
alternatively, the structure may have a geometry free of periodicity in a three-dimensional space;
the first P+S design variables of the first sequence and second P+S design variables of the second sequence may initially be generated randomly;
the electromagnetic source may be located outside or inside the structure;
each of the first design variables of the first sequence and second design variables of the second sequence may depend (or not depend) on a wavelength of an electromagnetic field generated by the electromagnetic source;
the electromagnetic source may generate an electromagnetic field that is a function of at least one spatial variable.

The invention also proposes a computer program product comprising a set of instructions which, when executed by processing means, is able to implement a method of the type presented above to optimize a structure comprising P sub-structures separated from each other by S spaces and each comprising at least one layer of a material, where P≥2 and S≥1, so that this structure has a selected response to an electromagnetic excitation selected by at least one electromagnetic source.

The invention also proposes a device to enable, for its production, the optimization of a structure comprising P sub-structures separated from each other by S spaces and each comprising at least one layer of a material, where P≥2 and S≥1, so that this structure has a selected response to an electromagnetic excitation selected by at least one electromagnetic source.

This device is characterized by the fact that it comprises at least one processor and at least one memory arranged to perform optimization operations that consist of calculating a figure of merit representative of a sensitivity of the selected response to first sequence variations in first design variables and second sequence variations in second design variables of the spaces and sub-structures, then calculating a gradient of the calculated figure of merit, subsequently modifying (for example gradually and successively) first or second design variables of at least one of the first and second sequences (for example starting with the most sensitive variable of the sequence concerned) depending on that calculated gradient in order to improve the figure of merit, and repeating the step of optimization with the first and second sequences of modified design variables as long as the figure of merit does not represent a set objective and/or the figure of merit is less than a selected value.

The invention also proposes an electronic apparatus comprising a device of the type presented above.

### BRIEF DESCRIPTION OF THE FIGURES

Other features and advantages of the invention will appear on examining the detailed description below, and the appended drawings, wherein:

FIG. 1 schematically illustrates an example of a structure defining a 1D metagrating deflecting a plane wave by an angle θ_{d} normal to its front face,

FIG. 2 schematically shows an example structure defining a meta-lens focusing a plane wave normal to its front face,

FIG. 3 schematically and functionally shows an embodiment of a computer comprising an optimization device according to the invention,

FIG. 4 schematically shows an example of an algorithm implementing an optimization method according to the invention,

FIG. 5 schematically illustrates a part of an example of a structure with the representation of the widths of its sub-structures and spaces and of the positions of the edges of these sub-structures,

FIG. 6 schematically shows a part of an example of updating the positions of the edges of the sub-structures of a structure during an iteration of the optimization step of the optimization method according to the invention,

FIG. 7 schematically shows an example of a structure being optimized with representation, on the left, of an electromagnetic source of the electric dipole type for forward simulations, and, on the right, of a plane wave electromagnetic source of the plane wave type for adjoint simulations, and

FIG. 8 schematically shows an example breakdown into functional blocks of an optimization device according to the invention.

### DETAILED DESCRIPTION OF THE INVENTION

One object of the invention is in particular to propose a method for optimizing physical and/or geometric (topological) parameters, or more clearly a method (100-230) for producing a structure comprising such optimization steps, as well as an associated device (in particular allowing optimization) 1, to allow the determination of structures 2, comprising each of the sub-structures 3ₚ (or 3) separated from each other by spaces 4ₛ (or 4), and each having a selected response to an electromagnetic excitation selected by at least one electromagnetic source 9 or 10.

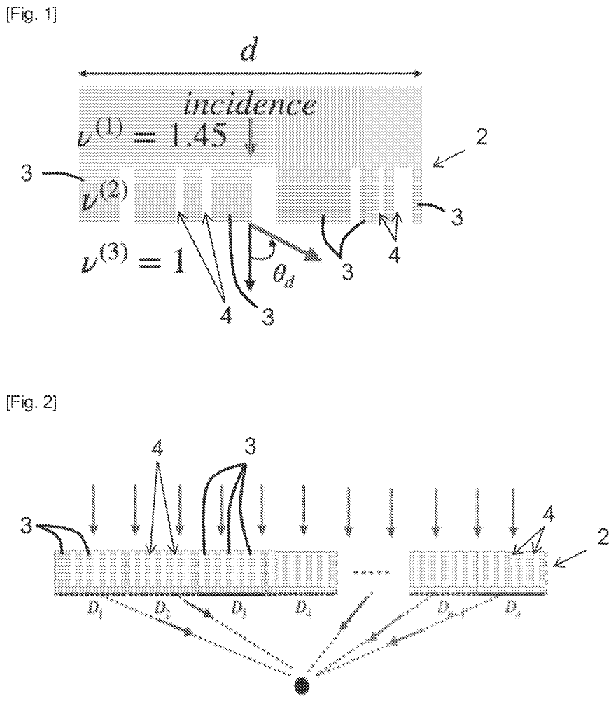

In what follows, as a non-limiting example, it is assumed that the structures 2 that are the subject of an optimization according to the invention are intended to form part of devices or equipment in the field of photonics. These structures for example define miniaturized gratings (or metagratings) charged to diffract the light at predefined deflection angles (as shown in a non-limiting manner in [FIG. 1]), or miniaturized lenses (or metalenses) responsible for focusing incident plane waves toward predefined focusing points (as shown in a non-limiting manner in [FIG. 2]). However, the invention is not limited to structures 2 in the field of photonics. Indeed, it relates to other technical fields, and in particular those of optics and of plasmonics. More generally, the invention relates to any type of structure 2 comprising P sub-structures 3ₚ (or 3) separated from each other by S spaces 4ₛ (or 4) and each comprising at least one layer of a material, where P≥2 and S≥1, and needing to have a selected response to an electromagnetic excitation selected by at least one electromagnetic source 9 or 10. It will be noted that the sub-structures 3ₚ which are located at the opposite ends of a structure 2 can also be preceded (or surrounded) by an additional space that can optionally be taken into account in the calculations.

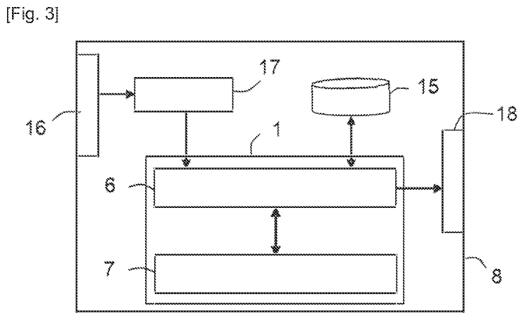

As indicated above, the invention in particular proposes a method (100-230) intended to allow the optimization of structures 2, of the type defined in the preceding paragraph. Such an optimization method (100-230) can be implemented by means of an optimization device 1, according to the invention, comprising at least one processor 6, for example a Digital Signal Processor (DSP), and at least one memory 7, as shown in a non-limiting manner in [FIG. 3].

This processor 6 and this memory 7 preferably form part of a computer 8, as shown in a non-limiting manner in [FIG. 3]. This computer 8 can be made in the form of a combination of electrical or electronic circuits or components and software modules. It will be noted that this computer 8 can be an electronic apparatus or may be part of an electronic apparatus, such as a computer (desktop or laptop) for example.

The memory 7 is random in order to store instructions for the processor 6 to implement at least part of the optimization method for an embodiment (100-230) described below (and therefore ensuring its functions).

The processor 6 may comprise integrated circuits (or printed circuits), or several integrated circuits (or printed circuits) connected by wired or wireless connections. An integrated (or printed) circuit is any type of device capable of performing at least one electrical or electronic operation.

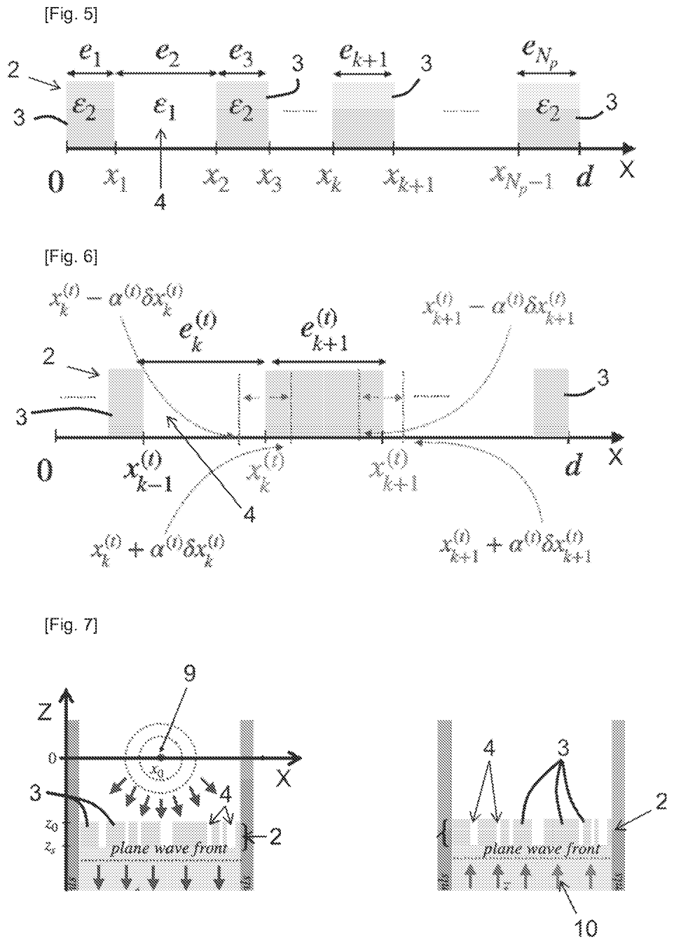

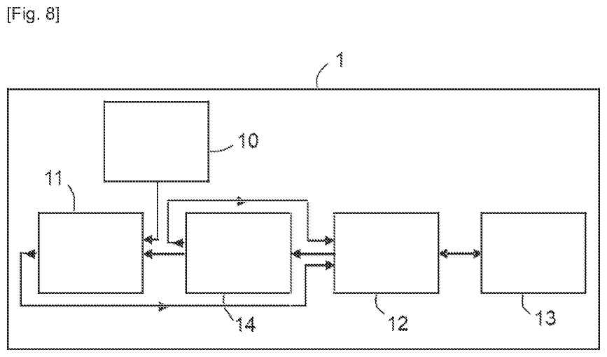

The method (100-230) according to the invention is implemented each time that it is desired to define a structure 2, which, as shown in [FIG. 1], [FIG. 2] and [FIG. 5] to [FIG. 7], comprises P sub-structures 3ₚ (p=1 to P) separated from each other by S spaces 4s (s=1 to S), where P≥2 and S≥1. It will be understood that between two adjacent sub-structures 3ₚ and 3ₚ₊₁, there is a space 4s. In addition, each sub structure 3ₚ comprises at least one layer of a material. In each of [FIG. 1], [FIG. 2] and [FIG. 5] to [FIG. 7] the sub-structures 3ₚ only comprise a single layer of material, but they could comprise at least two layers of material. Furthermore, once the optimization of the parameters has been completed, the structure 2 must have a selected response to an electromagnetic excitation selected by at least one electromagnetic source 9 or 10.

It will be noted that the structure 2 to be optimized can have a geometry having a periodicity in at least one of three different directions (X, Y, Z) of the three-dimensional space.

It will also be noted that the structure 2 to be optimized can have a geometry made of an arrangement, random or controlled, of sub-structures 3ₚ and of space(s) 4ₛ between substructures 3ₚ which forms at least one discrete elementary design and which has a canonical form selected, for example, from a group comprising a line, a rectangle, a cylinder, a sphere, a parallelepiped, a ring, and a set of concentric or off-center rings. In the examples shows in a non-limiting manner in [FIG. 1] and [FIG. 2], the sub-structures 3ₚ are lines having a rectangular cross section in a plane XZ.

However, alternatively, the structure 2 to be optimized may have a geometry devoid of periodicity in the three-dimensional space (X, Y, Z).

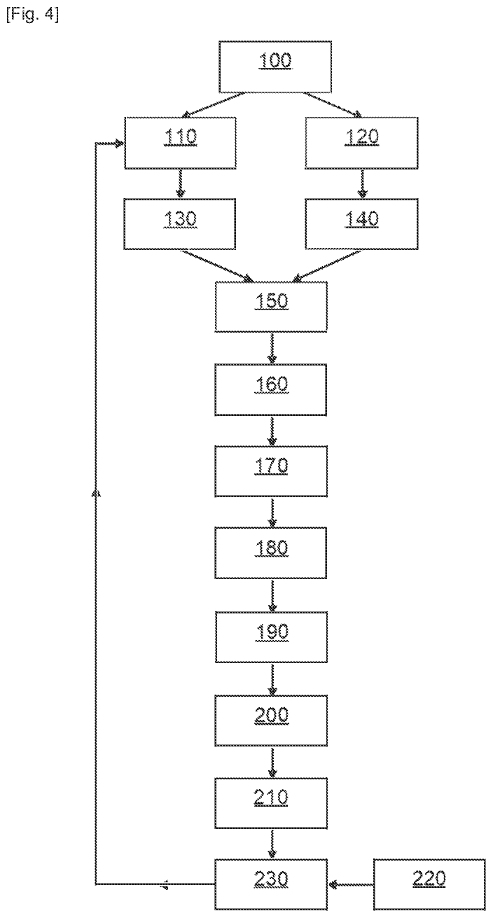

As shown in a non-limiting manner in [FIG. 4], the (100-230) according to the invention comprises an optimization step 110-230 wherein (the device 1) begins by calculating, for a structure 2, a figure of merit (or quality) FM which is representative of a sensitivity of the selected response of this structure 2 to first sequence variations in first design variables eₖ^{a} (or eₖ^{old}) and a second sequence of second design variables eₖⁿ (or eₖ^{new}) of the spaces 4ₛ and substructures 3ₚ.

For example, and as shown in a non-limiting manner in [FIG. 5], the first eₖ^{a} (or eₖ^{old}) and second eₖⁿ (or eₖ^{new}) design variables may respectively represent old and new widths of the substructures 3ₚ and spaces 4ₛ. In [FIG. 5] the direction X is the direction wherein the width eₖ of each sub-structure 3ₚ or space 4ₛ is determined, the xₖ represent the positions of the edges (or boundaries) of the substructures 3ₚ, and the ε represent the permittivities of the sub-structures 3ₚ. The index k here takes values between 1 and Nₚ−1, where Nₚ=P+S.

In general, a design variable of a structure 2 may be a geometric (or dimensional) variable of a sub-structure 3ₚ or a space 4ₛ or a physical variable of a sub-structure 3ₚ (as for example the creation of a layer of material or a permittivity or a refractive index or a conductivity or a chemical potential controlling the conductivity of a tunable material in real time).

The optimization step 110-230 of the method continues with the calculation (by the device 1) of a gradient g^{(t)}(xᵢ) of the figure of merit FM that has just been calculated (g(x)=∇FM(x)).

Then, the optimization step 110-230 of the method continues by the modification (by the device 1) of the first eₖ^{a} (or eₖ^{old}) or second eₖⁿ (or eₖ^{new}) design variables of at least one of the first and second sequences depending on this gradient g^{(t)}(xᵢ) that has just been calculated, to improve the figure of merit FM. Then, the step of optimization 110-230 is repeated (by the device 1) with the first and second sequences of design variables modified as long as the figure of merit FM does not represent a set objective and/or the figure of merit FM is less than a selected value.

As will be seen later, in the detailed example which is described, the first design variables eₖ^{a} (or eₖ^{old}) are modified during each optimization step 110-230 (including the first) depending on the gradient g^{(t)}(xᵢ) that has just been calculated. Only the initial second design variables eₖⁿ (or eₖ^{new}) are modified during the entire first optimization step 110-230, then the fourth design variables xₖⁿ (or xₖ^{new}) that are modified depending on the gradient g^{(t)}(xᵢ) that has just been calculated, during the following optimization steps 110-230.

During each iteration of the optimization step 110-230, it is possible to calculate in one go, at any point x; of the design domain I, the gradient g^{(t)}(xᵢ) of the objective function carried by the figure of merit FM. To do this, it is possible, for example, to use the “adjoint-based” method. For the calculation of the gradient g^{(t)} it is possible, for example, to consider that dummy currents are induced when the considered structure 2 changes from an “old” state (a) to a “new” state (n), as shown in [FIG. 6]. This switch may be due to a change in at least one geometric or physical parameter of the structure 2.

It can be shown that if E(r) is the electric vector field at a point of observation r, created by at least one electromagnetic source 9 or 10 located at a point r′, then the gradient of the figure of merit FM can be defined by the relationship:

∇FM(r)=(E(r)+δE(r))·(̅E̅(̅r̅)̅+̅δ̅E̅(̅r̅)̅−E(r)·E̅(̅r̅)̅,

and ignoring the terms of the second order, it is shown that

∇FM(r)=2*Rₑ(E̅(̅r̅)̅·δE(r)),

wherein the symbol “·” denotes the scalar product of two vectors and the overline denotes the conjugate complex. In addition, if it is assumed that a local variation of the physical properties at the source point r′ may induce a variation δE(r) in the electric vector field E(r) at the point of observation, then it is possible to show, using the integral formula of Stratton and Chu, that:

δE(r)=jk∫_{ω}[Z₀δE_{elec}(r,r′)+δE_{mag}(r,r′)+δE_{charg}(r,r′)]dω,

where k is the wavenumber and w denotes the area surrounding the computing domain. By subdividing the surface w into the elementary surfaces ωᵢ as follows:

ω=∪ᵢωᵢ,

the preceding relationship can be rewritten as follows:

δE(r)=Σᵢ∫_{r′}_{ₚ}_{εωi}\tilde{S}(r,r′ₚ)dr′_{p′},
where

\tilde{S}(r,r′ₚ)=jk[Z₀δE_{elec}(r,r′p)+δE_{mag}(r,r′ₚ)+δE_{charg}(r,r′ₚ)]

appears as the contribution of each element r′ₚ on each elementary surface ωᵢ at the radiated electric field E(r) calculated at the point of observation r:

$$\overline{E} ( r ) \cdot δ E ( r ) = {\sum }_{i} \overline{E} ( r ) \cdot {\int }_{{r}_{p}^{′} {ϵω}_{i}} \overline{S} ( r , {r}_{p}^{′} ) {dr}^{′} p$$

Using the reciprocity properties of the Green function and its gradient, it can be shown that

Ē(r)·δE(r)=Σᵢ∫_{r′}_{ₚ}_{εω}_{ᵢ}S(r′ₚ)·E^{adj}(r′ₚ,r)dr′ₚ.

The “adjoint” field, E^{adj}(r′ₚ, r) appears as the field radiated by sources placed in r to r′ₚ. If it is now considered that the source functions S(r′ₚ) are proportional to the variation of the electric induction field D(r′ₚ), then:

S(r′ₚ)≅γδD(r′ₚ)=γ[D_{new}(r′ₚ)−D_{old}(r′ₚ)].

Therefore, the variation in the figure of merit can be approximated as follows:

δF(r)=2 Re{Ē(r)·δE(r)}≅γΣᵢgₖ(r),

with

gₖ(r)=2 Re{∫_{r′}_{ₚ}_{∈ωk}δD(r′ₚ)·E^{adj}(r′ₚ,r)dr′ₚ}.

In other words, the local variation around a point r′ₖ of the design domain of the figure of merit FM is proportional to the variation of the electric induction D(r′ₖ) multiplied by the adjoint field.

In the field of design I, the permittivity ε(x) is discontinuous and can be described by a piecewise constant function. Therefore, a partition of the design domain I can be defined in sub-intervals {Iₖ,1≤k≤Nₚ} defined each by Iₖ=[xₖ₋₁,xₖ] and in each of which the permittivity ε(x) is constant.

Each iteration t will be noted that each sub-interval Iₖ may be associated with a sensitivity parameter gₖ^{t}(x) which may for example be defined from the g^{(t)} by:

$${g}_{k}^{( t )} = \frac{{\int }_{{I}_{k}^{( t )}} {xg}^{( t )} ( x ) dx}{{\int }_{{I}_{k}^{( t )}} xdx} .$$

This sensitivity parameter gₖ^{t}(x) is associated with a fitness parameter δxₖ^{(t)}. The utility of this fitness parameter δxₖ^{(t)} will be understood later on.

Instead of using a continuous initial profile describing the electromagnetic properties of the structure 2 and continuously modifying this profile in each voxel position of the design domain, as is the case with the topological optimization methods of the prior art, with the method, action is taken directly and gradually, continuously, on the widths of the discrete elements of the structure 2 (sub structures 3ₚ and spaces 4ₛ). This proves much more efficient and much faster, and therefore makes it possible to optimize larger and/or more complex structures 2, including when they are non-periodic diffraction metagratings or metasurfaces.

It will be noted, as shown in a non-limiting manner in [FIG. 4], that the method (100-230) may comprise an initialization step 100 before the entire first optimization step 110-230. In this initialization step 100, a first sequence of first P+S design variables eₖ^{a} (or eₖ^{old}) and a second sequence of second P+S design variables eₖⁿ (or eₖ^{new}) is generated (by the device 1). These first and second sequences of design variables are called initial sequences.

For example, these first P+Seₖ^{a} (or eₖ^{old}) and second P+Seₖⁿ (or eₖ^{new}) design variables may initially be randomly generated during the initialization step 100 by the device 1. But this is not mandatory. Indeed, it can be envisaged that the person who supervises the optimization is the one who defines the first P+Seₖ^{a} (or eₖ^{old}) and second P+Seₖⁿ (or eₖ^{new}) initial design variables.

The first P+S design variables eₖ^{a} (or eₖ^{old}) form a first (P+S)-tuple [eₖ^{a}]ₖ (or first sequence) and the second P+S design variables eₖⁿ (or eₖ^{new}) form a second (P+S)-tuple [eₖⁿ]ₖ (or second sequence) in the interval [eₘᵢₙ, eₘₐₓ], where eₘᵢₙ is the minimum width authorized for the initialization step for a sub-structure 3ₚ or a space 4ₛ and eₘₐₓ is the maximum width authorized for the initialization step for a sub-structure 3ₚ or a space 4ₛ. For example, for these random variables, the relationships can be used:

eₖ^{a}=eₘₐₓ−eₘᵢₙ)rₖ^{a}+eₘᵢₙ, and eₖⁿ=eₘₐₓ−eₘᵢₙ)rₖⁿ+eₘᵢₙ,

where the rₖ^{a} and the rₖⁿ are sets of random variables belonging to [0,1]^{N}^{ₚ}.

For a given parameter d, representing a period in the case of a periodic structure, or more generally the dimension of the computing domain (here along the direction X of the width), eₖ^{a} must satisfy Σₖ₌₁^{N}^{ₚ}eₖ^{a}=d and eₖⁿ must satisfy Σₖ₌₁^{N}^{ₚ}eₖⁿ=d. Therefore, the eₖ^{a} are normalized as follows:

$${e}_{k}^{a} = \frac{d {e}_{k}}{{Σ}_{q = 1}^{{N}_{p}} {e}_{q}^{a}}$$

and the eₖⁿ are normalized as follows:

$${e}_{k}^{n} = \frac{{de}_{k}}{{Σ}_{q = 1}^{{N}_{p}} {e}_{q}^{n}} .$$

After this initialization step 100, the first optimization step 110-230 is started wherein the first and second sequences of initial design variables are transformed (by the device 1) respectively into a third sequence of initial third P+S design variables xₖ^{a} (or xₖ^{old}) and a fourth sequence of initial fourth P+S design variables xₖⁿ (or xₖ^{new}).

For example, each of the third P+Sxₖ^{a} (or xₖ^{old}) and P+S fourth xₖⁿ (or xₖ^{new}) design variables can represent a sub-structure position 3ₚ or space 4ₛ between substructures 3ₚ position relative to an origin and along the X direction, of the three-dimensional space (X, Y, Z), according to which the width eₖ is defined, as shown in [FIG. 5] and [FIG. 6]. In this case, the width eₖ is an adjoined variable that restricts the space of the design phase of the structure 2 by fixing the positions of the sub-structures 3ₚ and spaces 4ₛ. For example, a represented position may be an edge (or boundary) or a center of a sub-structure 3ₚ or of a space 4ₛ. For example, each position of an edge (or of a boundary) xₖ^{a} or xₖⁿ can be equal to the sum between the preceding position xₖ₋₁^{a} or xₖ₁ⁿ and the corresponding first eₖ^{a} or second eₖⁿ design variable. In this case, the relationships obtained are:

xₖ^{a}=xₖ₋₁^{a}+eₖ^{a} and xₖⁿ=xₖ₋₁ⁿ+eₖⁿ, where x₀^{a}=x₀ⁿ=0 and k∈[1,Nₚ].

These new variables xₖ make it easier to obtain a close match between the thicknesses eₖ and the positions of the substructures 3ₚ during the optimization phase.

In the entire first optimization step 110-230, it is possible (for the device 1) to calculate the figure of merit FM from the third sequence of new third P+S design variables xₖ^{a} (or xₖ^{old}) and fourth P+S design variables xₖⁿ (or xₖ^{new}) of the fourth sequence. Then, in each iteration of the optimization step 110-230 it is possible (for the device 1) to calculate the figure of merit FM from the third sequence of new third P+S design variables xₖ^{a} (or xₖ^{old}) derived from transformations of the first design variables eₖ^{a} (or eₖ^{old}) determined during the preceding optimization step 110-230 and the fourth sequence of new fourth P+S design variables xₖⁿ (or xₖ^{new}) determined during the preceding optimization step 110-230.

It will be noted, as mentioned above, that in each optimization step 110-230 it is possible (for the device 1) to calculate P+S sensitivity parameters gₖ^{(t)} which are respectively dependent on the P+S components gₖ^{(t)}(xᵢ) of the gradient g^{(t)} of the figure of merit FM. In this case, it is possible (for the device 1) to then carry out in each optimization step at most P+S sub-iterations in each of which it is possible (for the device 1) to iteratively calculate a pair of fifth variables [xₖ^{(t)-}] and [xₖ^{(t)+}] respectively from the third sequence of the third P+S design variables, xₖ^{a} (or xₖ^{old}), from corresponding P+S sensitivity parameters gₖ^{(t)}, and from at least one selected constraint, preferably starting with the third design variable of the third sequence that is most sensitive, that is the one whose value of gₖ^{(t)} has the highest sensitivity, and ending with the lowest sensitivity. For example, each constraint may be selected from a group comprising the minimum width eₘᵢₙ and the maximum width eₘₐₓ.

The classification of the design variables in each sequence, according to their sensitivities, is based on the values of the gradient function of the figure of merit FM.

In order to increase the chances of convergence to the best results of the calculations of each of the P+S pairs of fifth variables [xₖ^{(t)-}] and [xₖ^{(t)+}], at each sub-iteration of each iteration (t) of the optimization step 110-230 the values taken by the sequence of sensitivity parameters gₖ^{(t)} can be classified in descending (or increasing) order and used to search for the position of each edge position variable (or boundary) xₖ which makes it possible to improve the figure of merit FM.

For example, each fifth variable [xₖ^{(t)-}] of a sequence may be given by the relationship:

[xₖ^{(t)-}=xₖ^{(t)}−δxₖ^{(t)}],

and each fifth variable [xₖ^{(t)}] of a sequence may be given by the relationship:

[xₖ^{(t)+}=xₖ^{(t)}+δxₖ^{(t)}].

In the last two relationships δxₖ^{(t)} is a shape parameter calculated from the sensitivity parameters gₖ^{(t)}:

δxₖ^{(t)}=α^{(t)}gₖ^{(t)},

where α^{(t)} is a parameter, calculated at the beginning of each iteration t, and decreasing to zero when the number of iterations increases. For example, this decreasing parameter can be defined by the relationship:

$${α}^{( t )} = {a}_{0} arctan ( 1 - \frac{t}{{t}_{max}} ) ,$$

where tₘₐₓ represents the maximum number of iterations t of the optimization step 110-230, and a₀ is a numerical control parameter attached to the first iteration of the optimization step 110-230.

Then, in each sub-iteration of iteration t, it is possible (for the device 1) to determine from each pair of fifth variables [xₖ^{(t)-}] and [xₖ^{(t)+}] and the third design variable [xₖ^{a(t)}] from which they are calculated, the best of these two variables ([xₖ^{(t)-}] and [xₖ^{(t)+}]) and third design variable [xₖ^{a(t)}] based on a selected criterion.

Each fitness parameter δxₖ^{(t)} calculated from the sensitivity parameter gₖ^{(t)} is therefore used at each sub-iteration to disrupt the current value of the edge (or boundary) position variable xₖ^{(t)} corresponding to at least one minimum width constraint cₘᵢₙ (imposed by the structure manufacturing technique), which can induce a possible variation (increase or decrease) of this disrupted value. Only the variation leading to the best improvement of the figure of merit FM (this is the aforementioned selected criterion) is retained to later define the new value of the edge (or boundary) position variable xₖ^{(t)} in question. The determination of each variation leading to the best improvement in the figure of merit FM can be carried out by means of a simulation.

It will be noted that the minimum width cₘᵢₙ may be different from eₘᵢₙ. This is because eₘᵢₙ and eₘₐₓ are used at the start during the generating of the initial conditions, whereas cₘᵢₙ is a minimum constraint that is imposed and taken into account during the optimization independently of the value of eₘᵢₙ.

Then, during each sub-iteration of iteration t, the third sequence of the third variables is updated (by the device 1) by replacing in this third sequence the element that is considered the best among the two fifth variables [xₖ^{(t)-}] and [xₖ^{(t)+}] and the element of the third sequence xₖ^{a} (or xₖ^{old}) used to calculate them. Then at the end of the at most P+S−1 sub-iterations of iteration t, it is possible (for the device 1) to constitute a new fourth sequence with the fully updated third sequence. It will be noted that each new fourth design variable xₖⁿ (or xₖ^{new}) is given by the relationship:

xₖⁿ=best(xₖ^{(t)-}=xₖ^{(t)}−δxₖ^{(t)},xₖ^{(t)+}=xₖ^{(t)}+δxₖ^{(t)},xₖ^{(t)}).

Then, it is possible (for the device 1) to calculate (update) a new second sequence of second P+S design variables eₖⁿ (or eₖ^{new}) each from two elements of the new fourth sequence of fourth P+S design variables xₖⁿ (or xₖ^{new}) and xₖ₋₁ⁿ (or xₖ₋₁^{new}). In other words, when the best set of new design variables xₖⁿ (or xₖ^{new}) has been determined, a new sequence of sub-structure widths 3ₚ and spaces 4ₛ is calculated. To do this, the relation mentioned above is used:

eₖⁿ=xₖⁿ−xₖ₋₁ⁿ.

Then, it is possible (for the device 1) to generate new first P+S design variables eₖ^{a} from respectively the corresponding new second P+S design variables eₖⁿ (or eₖ^{new}) and corresponding P+S noise parameters β^{(t)}rₖ. To do this, it is possible, for example, to apply random oscillations to the best set of new second design variables eₖⁿ by means of a mechanism of random contraction or expansion. To this end, it is possible, for example, to use the relationship:

eₖ^{a}=eₖⁿ+β₀β^{(t)}rₖ.

β₀ is a parameter for finely adjusting the widths eₖⁿ of the substructures 3ₚ and spaces 4ₛ between substructures 3ₚ so that the induced disruption does not excessively modify the values of eₖⁿ. For example, it is possible to select:

$${β}_{0} = min ( \frac{{[ {e}_{k}^{n} ]}_{k}}{ρ} ) ,$$

where ρ is an adjustable numerical parameter, for example equal to 10. [rₖ]=2rand(Nₚ, 1)−1 is a vector of random variables in the interval [−1,1]^{N}^{ₚ}, which simulates an uncertainty in the oscillation mode of the current vector [eₖⁿ]ₖ.

$${β}^{( t )} = arctan ( 1 - \frac{t}{{t}_{max}} )$$

is a parameter decreasing with the number of iterations of the optimization step 110-230. For example, it is possible to select:

$${β}_{0} = min ( \frac{{[ {e}_{k}^{n} ]}_{k}}{ρ} ) .$$

Finally, the device 1 can calculate a new third sequence of new third P+S design variables from the new first P+S design variables of the new first sequence of P+S to use it during the following iteration (t+1).

Preferably, in each optimization step 110-230 after the first optimization step 110-230, to serve as the at most P+S fourth design variables xₖⁿ (or xₖ^{new}), at most P+S new fourth variables xₖⁿ (or xₖ^{new}) which were generated during the preceding optimization step 110-230 are used (by the device 1). In addition, to serve as the at most P+S third design variables xₖ^{a} (or xₖ^{old}), at most P+S new third variables derived respectively from transformations of the P+S new first design variables eₖ^{a}, generated during the preceding optimization step 110-230, are used (by the device 1) as long as the figure of merit FM does not represent a set objective and/or the figure of merit FM is less than a selected value. In other words, the previous structure 2 is updated, then a new iteration is carried out as long as it has not converged to an optimal final structure 2 and the maximum number of iterations of the optimization step 110-230 has not yet been reached.

It will be noted that in each optimization step 110-230 it is possible (for the device 1) to calculate the figure of merit FM from forward and adjoint simulations using the corresponding third design variable xₖ^{a} (or xₖ^{old}), and from either a forward simulation using the corresponding fourth design variable xₖⁿ (or xₖ^{new}) during the first optimization step 110-230, or from the corresponding new fourth design variable xₖⁿ (or xₖ^{new}) in the preceding optimization step 110-230.

The forward and adjoint simulations, being well-known to the person skilled in the art, will not be described below. It can simply be stated that in each forward simulation and in each adjoint simulation, an electromagnetic source constituting a dipole, a source line, a plane wave or a guided mode of a waveguide can be used. By way of example, in each forward simulation, the device 1 may, for example, use an electromagnetic source 9 constituting a dipole (as shown schematically in the left part of [FIG. 7]), and in each adjoint simulation it is possible (for the device 1), for example, to use an electromagnetic source 10 generating plane waves (as shown schematically in the right part of [FIG. 7]).

It will be noted that an electromagnetic source 9 or 10 of the dipole or source line type may be located outside or inside the structure 2.

It will also be noted that each of the first design variables eₖ^{a} of the first sequence and second design variables eₖⁿ of the second sequence may depend on a wavelength of the electromagnetic field that is generated by the electromagnetic source. But alternatively, each of the first eₖ^{a} and second eₖⁿ design variables may be independent of a wavelength of the electromagnetic field that is generated by the electromagnetic source.

It will also be noted that the electromagnetic source 9 or 10 can generate an electromagnetic field which depends on at least one spatial variable. But this is not mandatory.

As an example, it is possible to optimize a structure 2 constituting a 1D diffraction meta-grating similar to that shown in [FIG. 1] and comprising linear sub-structures 3ₚ (bars) made of silicon, having a refractive index equal to 3.6082, a height (along Z) equal to 650 nm, and deposited on an SᵢO₂ substrate having a refractive index equal to 1.45, with a manufacturing constraint relating to the minimum width (cₘᵢₙ) equal to 50 nm. This structure 2 is intended to deflect electromagnetic waves having a wavelength equal to 0.9 μm at a deflection angle θ_{d} equal to 40°. 25 first P+S-tuples [eₖⁿ]ₖ and 25 second P+S-tuples [eₖ^{a}]ₖ in the interval [eₘᵢₙ, eₘₐₓ] are initially generated, and the maximum number of iterations of the optimization step 110-230 for each of the 25 pairs is set to 100 ([eₖⁿ]ₖ, [eₖ^{a}]ₖ). Furthermore, three values of P+S (=Nₚ) are tested, namely P+S=5 (3 sub-structures 3ₚ (p=1 to 3) and 2 spaces 4ₛ (s=1 and 2), P+S=7 (4 sub-structures 3ₚ (p=1 to 4) and 3 spaces 4ₛ (s=1 to 3), and P+S=9 (5 sub-structures 3ₚ (p=1 to 5) and 4 spaces 4ₛ (s=1 to 4). Whatever the value of P+S (=Nₚ), the final structure 2 has high performance (and therefore offers a response that is very close to the response initially selected). However, the larger the value of P+S (=Nₚ), the greater the performance. But in practice the larger the value of P+S (=Nₚ), the greater the manufacturing cost of the final structure 2, and consequently, it is possible to choose to manufacture a structure 2 having the smallest value of P+S (here equal to 5), since the performance difference with the structure having the largest value of P+S (here equal to 9) is very low (typically less than 0.5%). For example, if the computing times, in order to converge toward the final optimal structure 2 with a selected computer implementing the method according to the invention, are equal to 3996.5 s for P+S=5, 4861.5 s for P+S=7, and 5821.7 s for P+S=9, then the calculation time to converge toward a final optimal structure with this same computer selected but implementing a topological optimization method of the prior art using a continuous initial profile function defined by 2⁸ voxels is equal to 67247 s. It will be noted that in all the cases, there is more than one factor eleven of difference between the computing times according to the invention and according to the prior art.

An example of an algorithm implementing a method (100-230) according to the invention is described below and shown in [FIG. 4].

This algorithm comprises an optional initialization step 100 wherein an initial first sequence of P+S design variables eₖ^{a} (or eₖ^{old}) and an initial second sequence of second P+S design variables eₖⁿ (or eₖ^{new}) are generated.

Then, a first optimization step 110-230 is started. The latter begins with sub-steps 110 and 120 wherein the initial first and second sequences of design variables are transformed respectively into a third initial sequence of third P+S design variables xₖ^{a} (or xₖ^{old}) and fourth initial sequence of fourth P+S design variables xₖⁿ (or xₖ^{new}). Then, in sub-steps 130 and 140, forward and adjoint simulations using the current and corresponding third design variable xₖ^{a} (or xₖ^{old}), and a forward simulation using the current and corresponding fourth design variable xₖⁿ (or xₖ^{new}) are respectively carried out in order to calculate a figure of merit FM.

Then, in a sub-step 150, the gradient g^{(t)}(xᵢ) of the figure of merit FM is calculated.

Then, in a sub-step 160, P+S sensitivity parameters gₖ^{(t)} are calculated which are respectively a function of the P+S components g^{(t)}(xᵢ) of the gradient g^{(t)} of the figure of merit FM.

Then, in a sub-step 170, at most P+S sub-iterations are carried out in each of which a pair of fifth variables [xₖ^{(t)-}] and [xₖ^{(t)+}] is calculated iteratively from the third sequence of the third P+S design variables xₖ^{a} (or xₖ^{old)} respectively, from the corresponding P+S sensitivity parameters gₖ^{(t)}, and at least one selected constraint.

Then, in a sub-step 180, in each sub-iteration of iteration t, it is determined from each pair of fifth variables [xₖ^{(t)-}] and [xₖ^{(t)+}] and the third design variable [xₖ^{a(t)}] from which they are calculated, which is the best of these two variables ([xₖ^{(t)-}] and [xₖ^{(t)+}]) and third design variable [xₖ^{a(t)}] based on a selected criterion. That criterion may consist of each variation leading to the best improvement in the figure of merit FM.

Then, in a sub-step 190, in each sub-iteration of iteration t, the third sequence of third variables is updated by replacing in this third sequence the element that is considered as the best among the two fifth variables [xₖ^{(t)-}] and [xₖ^{(t)+}] and the element of the third sequence xₖ^{a} (or xₖ^{old}) used to calculate them. Then, in a sub-step 200 carried out at the end of the at most P+S−1 sub-iterations of iteration t, a new fourth sequence is formed with the updated third sequence. Then, in a sub-step 210, a new second sequence of second P+S design variables eₖⁿ(or eₖ^{new}) is calculated (updated), each from two elements of the new fourth sequence of fourth P+S design variables xₖⁿ (or xₖ^{new}) and xₖ₋₁ⁿ (or xₖ₋₁^{new}).

Then, in a sub-step 220, P+S noise parameters β^{(t)}rₖ are determined respectively corresponding to the P+S new second design variables eₖⁿ that were just calculated.

Then, in a sub-step 230, P+S new first design variables eₖ^{a} are generated from respectively the corresponding new second P+S design variables eₖⁿ (or eₖ^{new}) and the corresponding P+S noise parameters β^{(t)}rₖ.

Then, as long as it has not converged to an optimal final structure 2, and the maximum number of iterations of the optimization step 110-230 has not yet been reached, the optimization step 110-230 is repeated with the modified design variables, and more precisely here by using in its sub-step 110 the P+S new first design variables eₖ^{a} (determined in the last sub-step 230), to obtain P+S new third design variables xₖ^{a} (or xₖ^{old),} and in its sub-step 140 the P+S new fourth design variables xₖⁿ (or xₖ^{new}) (determined in the last sub-step 200).

It will be noted that one or more sub-steps of each optimization step 110-230 and/or the initialization step 100 of the method (100-230) can be carried out by different components. Thus, the method (100-230) can be implemented by a plurality of digital signal processors, random access memories, mass memories, input interfaces, output interfaces.

It will also be noted that the invention also proposes a computer program product (or computer program) comprising a set of instructions which, when executed by processing means of the electronic circuit (or hardware) type, such as, for example, the processor 6, is able to implement the method (100-230) described above.

It will also be noted, as shown in a non-limiting manner in [FIG. 8], that the device 1 can be broken down into five functional blocks.

A first functional block 10 ensures the initialization step 100 (optional).

A second functional block 11 ensures the transformations of the first P+S design variables eₖ^{a}(or eₖ^{old} respectively into third P+S design variables xₖ^{a} (or xₖ^{old)} during each optimization step 110-230, and the transformation of the second P+S initial design variables eₖⁿ (or eₖ^{new}) respectively into fourth P+S design variables xₖⁿ (or xₖ^{new}) during the entire first optimization step 110-230.

A third functional block 12 is responsible for performing all the forward and adjoint simulations during each optimization step 110-230.

A fourth functional block 13 is responsible for performing gradient calculations g^{(t)}(xᵢ) of the figure of merit FM, fitness parameters xₖ^{(t)}, and fifth variables [xₖ^{(t)-}] and [xₖ^{(t)+}], during each optimization step 110-230.

A fifth functional block 14 is responsible for determining the new fourth design variables xₖⁿ (or xₖ^{new}) the new second design variables eₖⁿ, the noise parameters β^{(t)}rₖ, and the new first design variables eₖ^{a}, during each optimization step 110-230.

It will also be noted that at least two types of modal methods can, for example, be used to solve the Maxwell's equations, namely the Fourier model method (FMM), the rigorous coupled-wave analysis (RCWA) method, and a polynomial modal method (PMM). The Fourier modal method (FMM) is particularly well suited to 1 D, 2D or 3D periodic structures. In the case of non-periodic structures, it is possible to use an aperiodic Fourier model method (AFMM)), which combines a solver for periodic systems with perfectly matched layers (or PMLs) by means of a change of complex coordinates. This requires describing the incident plane wave (input field) and the non-periodic diffracted field in the same formalism by introducing a hybrid method combining a Fourier base, Maxwell's equations in complex coordinates, and Stratton and Chu's integral formalism. However, in the case of metallic structures or structures with a high index contrast, it is preferable to use a polynomial modal method (PMM) or an aperiodic polynomial modal method (APMM).

It will also be noted, as shown in a non-limiting manner in [FIG. 2], that the computer 8 can also comprise, in addition to the device 1 (random access memory 7 and processor 6), a mass memory 15. Furthermore, this computer 8 may also comprise an input interface 16 for receiving instructions and data, for use in calculations or processing, optionally after having been shaped and/or demodulated and/or amplified, in a manner known per se, by means of a digital signal processor 17. In addition, this computer 8 may also comprise an output interface 18, in particular to deliver messages and the results of each optimization.

1. A method for producing a structure comprising P sub-structures (3ₚ) that are separated from each other by S spaces (4ₛ) and that each comprises at least one layer of a material, where P≥2 and S≥1, such that said structure has a selected response to an electromagnetic excitation selected by at least one electromagnetic source, characterized in that it comprises an optimization step involving calculating a figure of merit representative of the sensitivity of the selected response to first sequence variations in first design variables and second sequence variations in second design variables of the spaces (4ₛ) and substructures (3ₚ), then calculating a gradient of the calculated figure of merit, subsequently modifying first or second design variables of at least one of the first and second sequences depending on said calculated gradient in order to improve the figure of merit, and repeating the optimization step as long as the figure of merit does not represent a set objective and/or said figure of merit is less than a selected value, wherein the first P+S design variables of the first sequence and the second P+S design variables of the second sequence are substructure (3ₚ) or space (4ₛ) widths between substructures (3ₚ), which widths are defined in one of three different directions of a three-dimensional space.

2. The method according to claim 1, characterized in that it comprises an initialization step wherein first and second design variables sequences are generated, referred to as initial sequences and each comprising P+S design variables, and in that, in a first optimization step, these initial first and second design variable sequences are transformed respectively into an initial third sequence of third P+S design variables and an initial fourth sequence of fourth P+S design variables, and then said figure of merit is calculated from these third P+S design variables of the third sequence and fourth P+S design variables of the fourth sequence, and then in each iteration of said optimization step, said figure of merit is calculated from the third sequence of new P+S design variables derived from transformations of said first sequence of first P+S design variables determined during the previous optimization step and of the fourth sequence of new fourth P+S design variables determined during the preceding optimization step, wherein each of said third design variables of the third sequences and fourth P+S design variables of the fourth sequences represents a substructure position (3ₚ) or space (4ₛ) between substructures (3ₚ) position with respect to an origin and along the direction of three-dimensional space wherein the width is defined, each position being equal to a sum between a previous position and the corresponding first or second design variable.

3. The method according to claim 2, characterized in that in each optimization step, in a sub-step of optimizing at most P+S sub-iterations, a sequence of at most P+S sensitivity parameters depending respectively on said gradient of the figure of merit is calculated, then at each of the P+S sub-iterations a pair of fifth variables is calculated iteratively from respectively said third P+S design variables of the third sequence, said corresponding P+S sensitivity parameters, and at least one selected constraint, starting with the third design variable having the strongest sensitivity in the third sequence, and ending with the third design variable having the lowest sensitivity, then from a triplet comprising said pair of fifth variables calculated during the considered sub-iteration of the current iteration and the third design variable from which the fifth variables are calculated, the best of these two fifth variables and of this third design variable according to a chosen criterion are determined, then a new third sequence of at most P+S third design variables composed of the best of these two fifth variables and third design variable according to a chosen criterion and from the remainder of the sequence of at most P+S−1 remaining third design variables is updated, then a new fourth sequence is constituted with the updated third sequence, then a new second sequence of new second P+S design variables is calculated from said new fourth sequence of fourth design variables, then a new first sequence of new first P+S design variables is generated from respectively the new second P+S design variables of said new second sequence and from P+S corresponding noise parameters, then a new third sequence of new third P+S design variables is calculated from the new first P+S design variables of said new first P+S sequence.

4. The method according to claim 3, characterized in that each constraint is selected from a group comprising a minimum width and a maximum width.

5. The method according to claim 2, characterized in that in each optimization step said figure of merit is calculated from forward and adjoint simulations using the third variable of corresponding design, and either from a forward simulation using the fourth variable of corresponding design during the first optimization step, or from the new fourth variable of corresponding design generated during the preceding optimization step.

6. The method according to claim 5, characterized in that in each forward simulation and in each adjoint simulation, an electromagnetic source constituting a dipole, a source line, a plane wave or a guided mode of a waveguide is used.

7. The method according to claim 1, characterized in that said structure has a geometry having a periodicity in at least one of three different directions of a three-dimensional space.

8. The method according to claim 7, characterized in that said structure has a geometry made of an arrangement of sub-structures (3ₚ) and of space(s) (4ₛ) between substructures (3ₚ) forming at least one discrete elementary design and which has a canonical form selected, for example, from a group comprising a line, a rectangle, a cylinder, a sphere, a parallelepiped, a ring, and a set of concentric or off-center rings.

9. The method according to claim 1, characterized in that said structure has a geometry devoid of periodicity in a three-dimensional space.

10. The method according to claim 1, characterized in that said P+S design variables of the first sequence and second P+S design variables of the second sequence are initially generated randomly.

11. The method according to claim 1, characterized in that said electromagnetic source is located outside said structure or inside said structure.

12. The method according to claim 1, characterized in that each of said first design variables of the first sequence and second design variables of the second sequence is a function of a wavelength of an electromagnetic field generated by said electromagnetic source.

13. The method according to claim 1, characterized in that said electromagnetic source generates an electromagnetic field based on at least one spatial variable.

14. A computer program product comprising a set of instructions which, when executed by processing means, is able to implement a method according to one of the preceding claims to optimize a structure comprising P sub structures (3ₚ) separated from each other by S spaces (4ₛ) and each comprising at least one layer of a material, where P≥2 and S≥1, so that this structure has a selected response to an electromagnetic excitation selected by at least one electromagnetic source.

15. A device for the production of a structure comprising P sub-structures (3ₚ) separated from each other by S spaces (4ₛ) and each comprising at least one layer of a material, where P≥2 and S≥1, so that said structure has a selected response to an electromagnetic excitation selected by at least one electromagnetic source, characterized in that it comprises at least one processor and at least one memory arranged to perform the optimization operations consisting of calculating a figure of merit representative of a sensitivity of the selected response to first sequence variations in first design variables and second sequence variations in second design variables of said spaces (4ₛ) and substructures (3ₚ), then calculating a gradient of said calculated figure of merit, subsequently modifying first or second design variables of at least one of the first and second sequences depending on said calculated gradient in order to improve the figure of merit, and repeating the optimization step as long as the figure of merit does not represent a set objective and/or said figure of merit is less than a selected value.

16. An electronic apparatus, characterized in that it comprises a device according to claim 15.
